(19) United States
(12) Patent Application Publication
(10) Pub. No.: US 2016/0248829 A1
(43) Pub. Date: Aug. 25, 2016

(54) Availability Start Time Adjustment By Device For DASH Over Broadcast

(71) Applicant: QUALCOMM Incorporated, San Diego, CA (US)

(72) Inventors: Nermeen Ahmed Bassiouny, San Diego, CA (US); Thadi Manjunath Nagaraj, San Diego, CA (US); Nagaraja Shivashankar, San Diego, CA (US); Ralph Akram Gholmieh, Poway, CA (US)

(21) Appl. No.: 15/041,366

(22) Filed: Feb. 11, 2016

Related U.S. Application Data
(60) Provisional application No. 62/119,353, filed on Feb. 23, 2015.

(51) Int. Cl. H04L 29/06; H04L 29/08; H04L 12/26

(52) U.S. Cl. CPC H04L 65/4076; H04L 69/22; H04L 43/106; H04L 43/087; H04L 65/601; H04L 67/02

(57) ABSTRACT

Systems, methods, and devices of the various embodiments enable a device to use a modified segment availability time. In various embodiments, a Broadcast Multimedia Service Center (BMSC) server may be enabled to modify a segment availability timeline in which the availability times of the segments. In various embodiments, segment availability time adjustments may be made at a service layer of the receiver device. In various embodiments, segment availability time adjustments may be made by a client application on the receiver device.

### RELATED APPLICATION

The present application claims priority to U.S. Provisional Patent Application No. 62/119,353 entitled “Availability Start Time Adjustment By Device For DASH Over Broadcast” filed Feb. 23, 2015, the entire contents of which are hereby incorporated by reference.

### BACKGROUND

Hypertext Transfer Protocol (HTTP) streaming is currently the most popular method of delivering content over the Internet. For live events, content is made available progressively through constant duration segments. The segment availability follows a timeline that indicates when each successive segment becomes available at the HTTP server.

Dynamic Adaptive Streaming Over Hypertext Transfer Protocol (DASH) is a standard that implements HTTP streaming. DASH announces the segment availability in a Media Presentation Description (MPD). The MPD is a segment availability timeline that announces the segments, the times segments are available, and the size of the segments.

In current systems, the MPD is provided to a receiver device via Over-the-Air (OTA) delivery. In the provided MPD, the segment availability times may be selected to account for a maximum path delay that is estimated to occur between the encoder output and the receiver device reception of the segment. However, not all receiver devices in a network will experience the maximum path delay. Thus, receiver devices in lower delay areas that use the segment availability times in current MPDs can experience longer channel acquisition and switch times than necessary because the maximum path delay is longer than the actual delay experienced by the receiver devices in lower delay areas.

### SUMMARY

The systems, methods, and devices of the various embodiments enable a device to use a modified segment availability time. In various embodiments, a Broadcast Multimedia Service Center (BMSC) server may be enabled to modify a segment availability timeline in which the availability times of the segments. In various embodiments, segment availability time adjustments may be made at a service layer of the receiver device. In various embodiments, segment availability time adjustments may be made by a client application on the receiver device.

Various embodiments may include receiving a segment availability timeline at a device, receiving a File Delivery Table (FDT) packet at the device, the FDT packet including a FDT timestamp, determining an FDT arrival time at the device, determining an actual availability start time at the device based at least in part on the FDT arrival time and the FDT timestamp, and shifting a start time of the segment availability timeline based at least in part on the determined actual availability start time.

Various embodiments may include determining a transmission time of the FDT packet, indicating a FDT timestamp in the FDT packet in which the FDT timestamp is based at least in part on the determined transmission time, and transmitting the FDT packet at the determined transmission time.

Further embodiments include a device configured with processor executable instructions to perform operations of the methods summarized above. Further embodiments include a device including means for performing functions of the methods summarized above. Further embodiments include a non-transitory processor-readable storage medium having stored thereon processor-executable instructions configured to cause a device processor to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a block diagram illustrating the architecture of a receiver device according to an embodiment.

FIG. 3A illustrates the relationship between a segment delivery path and MPD delivery adjustments according to an embodiment.

FIG. 3B illustrates the relationship between a segment delivery path and MPD delivery adjustments according to another embodiment.

FIG. 4 illustrates the relationship between delivery path delays in different parts of a network according to an embodiment.

FIG. 5 illustrates availability time lines, MPD availability start times, transmission times, and arrival times according to an embodiment.

FIG. 6A is a process flow diagram illustrating an embodiment method for modifying a segment availability timeline.

FIG. 6B is a process flow diagram illustrating an embodiment method for generating a delay adjustment message.

FIG. 7 is data structure diagram of an Asynchronous Layered Coding (ALC) packet according to an embodiment.

FIG. 8 illustrates MPD availability start times, transmission times, arrival times, and off set times according to an embodiment.

FIG. 9A is a process flow diagram illustrating another embodiment method for modifying a segment availability timeline.

FIG. 9B is a process flow diagram illustrating another embodiment method for generating a delay adjustment message.

FIG. 10A is a process flow diagram illustrating an embodiment method for indicating a FDT timestamp in a File Delivery Table (FDT).

FIG. 10B is a process flow diagram illustrating another embodiment method for indicating a FDT timestamp in an FDT.

FIG. 10C is a process flow diagram illustrating a third embodiment method for indicating an FDT timestamp in an FDT.

FIG. 11 is a process flow diagram illustrating an embodiment method for adjusting availability times based on a delay adjustment message.

FIG. 12 is a component diagram of an example mobile device suitable for use with the various embodiments.

FIG. 13 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device” and “receiver device” are used interchangeably herein to refer to any one or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for receiving an MPD and making the MPD available to a DASH client.

The various embodiments are described herein using the term “server” to refer to any computing device capable of functioning as a server, such as a master exchange server, web server, mail server, document server, content server, or any other type of server. A server may be a dedicated computing device or a computing device including a server module (e.g., running an application that may cause the computing device to operate as a server). A server module (e.g., server application) may be a full function server module, or a light or secondary server module (e.g., light or secondary server application) that is configured to provide synchronization services among the dynamic databases on receiver devices. A light server or secondary server may be a slimmed-down version of server-type functionality that can be implemented on a receiver device thereby enabling it to function as an Internet server (e.g., an enterprise e-mail server) only to the extent necessary to provide the functionality described herein.

Dynamic Adaptive Streaming Over Hypertext Transfer Protocol (DASH) is a standard that implements HTTP streaming. DASH announces the segment availability in a Media Presentation Description (MPD). The MPD is a segment availability timeline that announces the segments, the times segments are available, and the size of the segments. In current systems, the MPD is provided to a receiver device via Over-the-Air (OTA) delivery. The Third Generation Partnership Project (3GPP) has standardized DASH over Download Delivery as a method to be used for providing HTTP streaming using broadcast over Long Term Evolution (LTE) (i.e., evolved Multimedia Broadcast Multicast Services (eMBMS)).

Various examples of different applications/clients, middleware, segment availability timelines, radio technologies, and transport protocols are discussed herein, specifically DASH clients, Multicast Service Device Clients, MPDs, eMBMS, and HTTP. The discussions of DASH clients, Multicast Service Device Clients, MPDs, eMBMS, and HTTP are provided merely as examples to better illustrate the aspects of the various embodiments, and are not intended to limit the various embodiments in any way. Other applications/clients, middleware, segment availability timelines, radio technologies, and transport protocols may be used with the various embodiments, and the other applications/clients, middleware, segment availability timelines, radio technologies, and transport protocols may be substituted in the various examples without departing from the spirit or scope of the invention. For instance, various embodiments may use segments formatted according to one or more other adaptive streaming protocols, such as, HTTP Live Streaming (“HLS”), that may use other segment availability timelines, such as, an HLS index file, that may have a start time.

The various embodiments enable devices, such as receiver devices, Broadcast Multimedia Service Center (BMSC) servers, etc., to account for delays in the availability of data segments (“segment availability”) in a data stream for use on the devices. In an embodiment, a receiver device may adjust the availability times in a segment availability timeline received from a network (e.g., an MPD received OTA from a BMSC server) to generate a modified MPD listing based on the actual times received segments will be available to applications/clients on the receiver device (e.g., a DASH client retrieving segments for a media player application). In another embodiment, a BMSC may adjust the availability times in a segment availability timeline received from a network (e.g., an MPD received OTA from an encoder and/or segmenter) to generate a modified MPD listing based on the actual times received segments will be available for transmission from the BMSC server.

In various embodiments, a device, such as a receiver device, BMSC server, etc., may receive an MPD with the availability start time (AST) of the segments set to an initial start time set by an encoder (AST1) or a worst case start time (AST3). The worst case start time may be a start time for the segments identified in the MPD selected based at least in part on the estimated worst case delay (delayMAX) for transmissions of packets to the device via a network. The device may receive a File Delivery Table (FDT) packet and determine the FDT arrival time (tnr) of that packet. In various embodiments, the FDT packet may include a timestamp indicated in the FDT packet from the sending device (e.g., a BMSC server sending packets to a receiver device, an encoder sending packets to a BMSC server, etc.) reflecting the FDT packet transmission time (tnt) plus a transmission delay (Δ1) and a processing delay (Δ2). The timestamp may be a single value indicative of the FDT packet transmission time (tnt) plus the delays (Δ1 and Δ2) (e.g., a value equal to (Δ1+Δ42−tnt) or may be three separate values (e.g., tnt, Δ1, and Δ2). When the MPD indicates a worst case delay start time (AST3), the transmission time tnt of the FDT packet may be shifted by the worst case delay (e.g., tnt=tnt+delayMAX) to account for the shift in MPD start time. The device may determine the means for performing network jitter estimate actual availability start time (AST2) as the availability start time of the segments indicated in the MPD (e.g., AST1 or AST3) indicated in the MPD plus the transmission delay (Δ1) plus the processing delay (Δ2) plus the determined FDT arrival time (tnr) minus the value if the FDT packet transmission time (tnt) plus the segment duration (D). The device may shift the MPD start time (AvailabilityStartTime) to the actual availability start time (AST2) plus a determined network jitter estimate. In this manner, the timestamp of the FDT packet may be used to shift the start times of the MPD without needing to wait for a complete arrival of a segment.

In various embodiments, a device, such as a receiver device, BMSC server, etc., may receive an MPD with the availability start time (AST) of the segments set to any start time. The device may receive a File Delivery Table (FDT) packet and determine the FDT arrival time (t2) of that packet. In various embodiments, the FDT packet may include a timestamp indicated in the FDT packet from the sending device (e.g., a BMSC server sending packets to a receiver device, an encoder sending packets to a BMSC server, etc.) reflecting the offset time (PacketOffset) of the transmission time of the FDT packet (t1) from the availability start time indicated in the MPD the sending device originally received (AST1), e.g., (PacketOffset=t1−AST1). The timestamp may be a single value indicative of the FDT packet transmission time (t1) minus the availability start time indicated in the MPD the sending device originally received (AST1) (e.g., a value equal to (t1−AST1)) or may be two separate values (e.g., (t1) and (AST1)). The device may determine the actual availability start time (AST2) as the determined FDT arrival time (t2) minus the offset time (PacketOffset) (e.g., t1−AST1). The device may shift the MPD start time (AvailabilityStartTime) to the actual availability start time (AST2) plus a determined network jitter estimate. In this manner, the timestamp of the FDT packet may be used to shift the start times of the MPD without needing to wait for a complete arrival of a segment and regardless of any delay used to generate the availability start time in the MPD as received by the device.

In various embodiments, the modified MPD with the shifted MPD start time may be stored in a memory of the device, such as a receiver device, BMSC server, etc., and segments may be requested by the device at the shifted MPD start time based on the modified MPD. In various embodiments, the device, such as a receiver device, BMSC server, etc., may store an indication of the shifted MPD start time (AvailabilityStartTime) in a delay adjustment message. A delay adjustment message may be parameter and/or indication of a delay adjustment, such as a file including a delay adjustment. In an embodiment, the delay adjustment message may enable another application, such as a client application on the receiver device, to modify the availability times in a segment availability timeline received from a network (e.g., an MPD received OTA from a Broadcast Multimedia Service Center (BMSC) server) to generate a modified MPD listing based on the actual times received segments will be available to applications/clients on the receiver device (e.g., a DASH client retrieving segments for a media player application). In another embodiment, the delay adjustment message may enable another application, such as a client application on the receiver device, to adjust the timing of its requests for segments based on the actual times received segments will be available to applications/clients on the receiver device (e.g., a DASH client retrieving segments for a media player application) without modifying the segment availability timeline itself.

In an embodiment, network jitter estimates (e.g., network jitter values) may be provided in a manifest file that describes the segment availability timeline (e.g., MPD) sent to the receiver device. In another embodiment, the network jitter may be pre-provisioned on the receiver device (e.g., stored in a non-volatile memory of the receiver device at the time of manufacture). In other embodiments, the network jitter estimate may be delivered to the receiver device in any message, such as in a service announcement. In an embodiment, the network jitter estimate may be delivered to the receiver device in a message independent of the message in which a MPD may be delivered. As used herein, “jitter” refers to the difference between earliest and latest possible arrival times of a segment as a difference from the availability timeline of the segment.

In the various embodiments, the FDT timestamp may be indicated in the FDT in any manner. As an example, the FDT timestamp may be indicated in standard ALC packet header fields, such as the sender current time field (SCT field). As another example, an extension header, such as a 64 bit field, may be added as an ALC extension header to pass the FDT timestamp. As a further example, an extension header, such as a 64 bit field, may be added as an FDT extension header to pass the FDT timestamp. As a further example, three separate 32 bit fields may be added to an ALC extension header, one for each value FDT packet transmission time (tnt), transmission delay (Δ1), and processing delay (Δ2). As another example, a single 32 bit field may be added to an ALC extension header to indicate the value of the sum of the values for FDT packet transmission time (tnt), transmission delay (Δ1), and processing delay (Δ2) (e.g., a value equal to tnt+Δ1−Δ2).

Various embodiments provide methods for modifying a segment availability timeline based on additional information beyond merely device- (e.g., a receiver device, BMSC server, etc.) determined information, such as the time at which the device receives a segment. The various embodiments provide methods for modifying a segment availability timeline based on both device-determined information (e.g., a FDT arrival time) and information determined external to a device, such as information provided by a network (e.g., a FDT timestamp). For example, various embodiments provide methods for transmitting FDT packets that indicate a FDT timestamp that is based at least in part on a determined transmission time of the FDT packet. A device may receive the FDT packet indicating the FDT timestamp and determine both when the FDT packet actually arrived at the device (e.g., the FDT arrival time) and the transmission time of the FDT packet as indicated by the FDT timestamp. The use of both device determined information (e.g., a FDT arrival time) and information determined external to a device (e.g., a FDT timestamp) in modifying a segment availability timeline may result in the device determining a more accurate availability start time for a segment availability timeline than if the device had determined the actual availability start time based only on device-determined information (e.g., a FDT arrival time).

Various examples of different devices modifying MPD availability start times are discussed herein, specifically receiver devices and BMSC servers. The discussions of receiver devices and BMSC servers are provided merely as examples to better illustrate the aspects of the various embodiments, and are not intended to limit the various embodiments in any way. Other devices may be used with the various embodiments to modify MPDs, and the other devices may be substituted in the various examples to modify MPDs without departing from the scope of the invention.

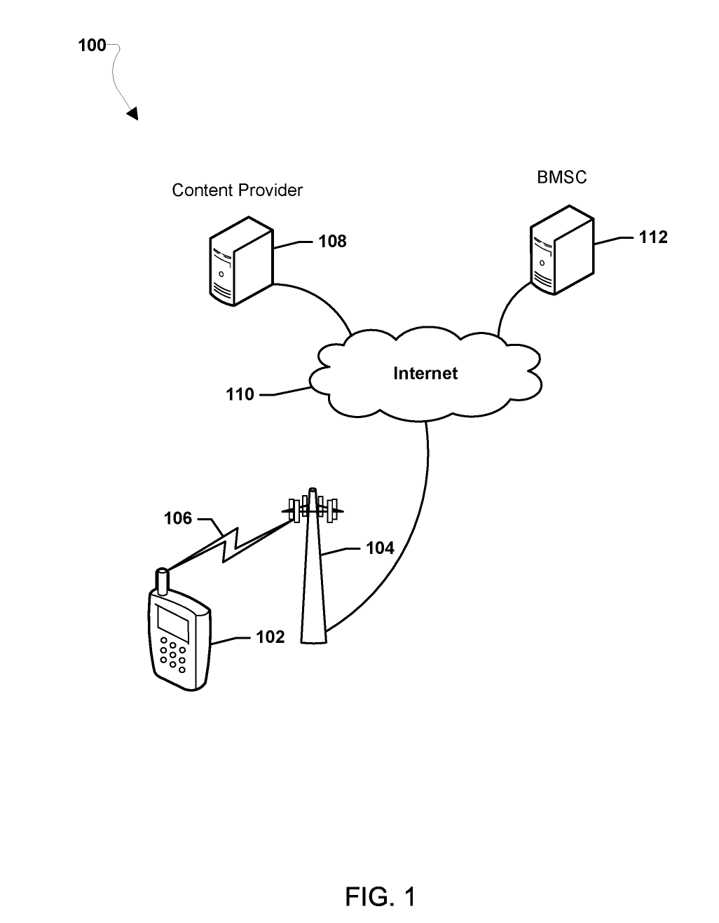

FIG. 1 illustrates a cellular network system 100 suitable for use with the various embodiments. The cellular network system 100 may include multiple devices, such as a receiver device 102, one or more cellular towers or base stations 104, and servers 108 and 112 connected to the Internet 110. The receiver device 102 may exchange data via one or more cellular connections 106, including CDMA, TDMA, GSM, PCS, 3G, 4G, LTE, or any other type connection, with the cellular tower or base station 104. The cellular tower or base station 104 may be in communication with a router that may connect to the Internet 110. In this manner, via the connections to the cellular tower or base station 104, and/or Internet 110, data may be exchanged between the receiver device 102 and the server(s) 108 and 112. In an embodiment, server 108 may be a content provider server or encoder providing MPDs and segments for output via a DASH client. In an embodiment, server 112 may be a Broadcast Multimedia Service Center (BMSC) server that may receive MPDs and segments output from the encoder and control the OTA transmission of the MPDs and segments to the receiver device 102. Of course, while features of receiver devices described herein may be described with reference to OTA transmissions, these features may be used in connection with wired transmissions, wireless transmissions, or a combination of wired and wireless transmissions. Thus, OTA transmission is not required.

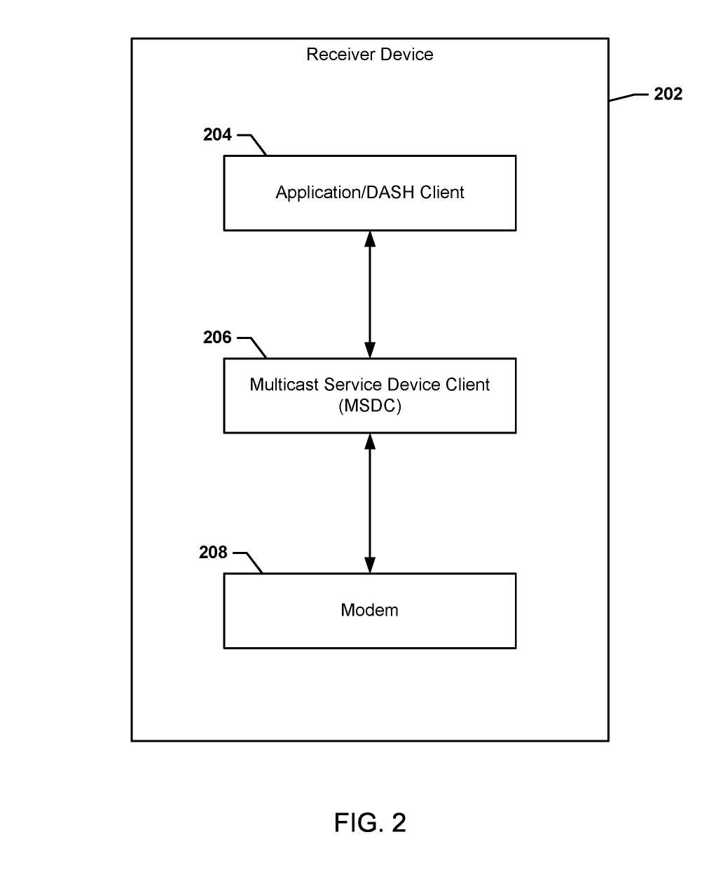

FIG. 2 illustrates a simplified receiver device 202 architecture according to an embodiment. The receiver device 202 may include a modem layer 208 that manages all radio aspects of the receiver device 202, such as acquisition, handoff, link maintenance, etc. The modem layer 208 may decode a received eMBMS bearer signal and deliver Internet Protocol (IP) packets to the Multicast Service Device Client (MSDC) 206. The Multicast Service Device Client 206 may be a service layer of the receiver device 202 that recovers segments from the delivered IP packets and makes segments available to applications/clients, such as Application/DASH client 204. As an example, the Multicast Service Device Client 206 may be a service layer that is part of the operating system of the receiver device 202. The Multicast Service Device Client 206 may also recover an MPD from the delivered IP packets. The Multicast Service Device Client 206 may store received segments in a memory of the receiver device. In an embodiment, the Multicast Service Device Client 206 may adjust the MPD to generate a modified MPD, store the modified MPD in a memory of the receiver device, and may deliver the modified MPD to the Application/DASH client 204. In another embodiment, the Multicast Service Device Client 206 may determine a delay adjustment for the MPD, store the delay adjustment for the MPD in a memory of the receiver device (e.g., in a delay adjustment message), store the MPD in a memory of the receiver device, and deliver the MPD and the delay adjustment for the MPD to the Application/DASH client 204. The Application/DASH client 204 may be a DASH enabled application and/or an application that launches a DASH client to present media (directly and/or via another application such as a media player). In an embodiment, the Application/DASH client 204 may obtain the modified MPD location (e.g., Uniform Resource Locator (URL)) from the Multicast Service Device Client 206, request and receive the modified MPD from the Multicast Service Device Client 206, and may request segments from the Multicast Service Device Client 206 per the availability timeline in the modified MPD. In another embodiment, the Application/DASH client 204 may obtain the MPD location (e.g., Uniform Resource Locator (URL)) from the Multicast Service Device Client 206 and the delay adjustment for the MPD location (e.g., URL), request and receive the MPD and the delay adjustment for the MPD from the Multicast Service Device Client 206, modify the MPD according to the delay adjustment for the MPD to generate a modified MPD, and request segments from the Multicast Service Device Client 206 per the availability timeline in the modified MPD. The Application/DASH client 204 may receive the requested segments from the Multicast Service Device Client 206 and may render the segment contents (directly and/or via another application such as a media player). In a further embodiment, the functions of the Multicast Service Device Client 206 used to determine a delay adjustment for the MPD may be integrated into the client 206 and the client 206 may determine delay adjustments and/or modify the MPD itself.

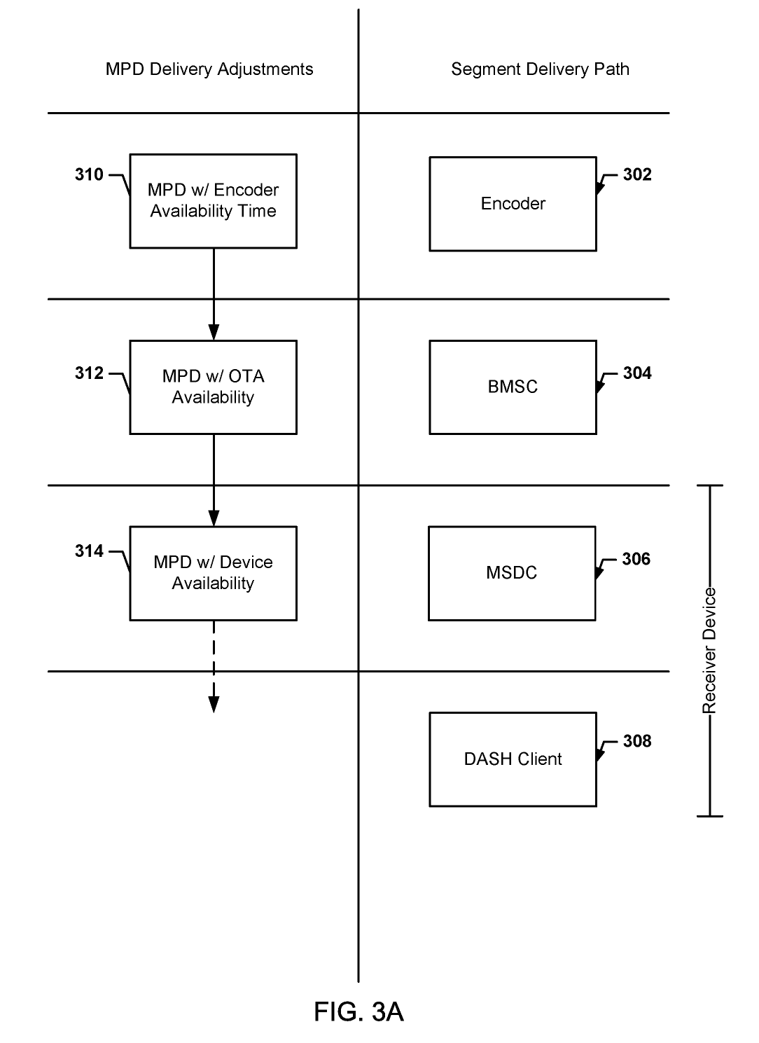

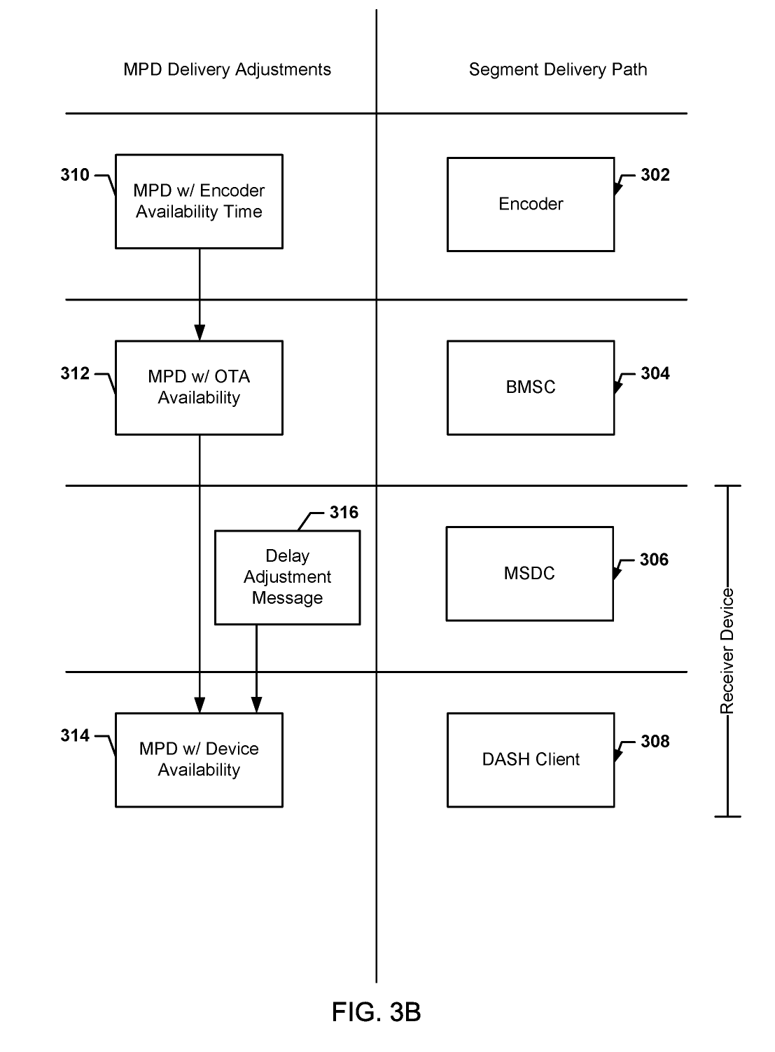

FIG. 3A illustrates the delivery adjustments that may be made to a segment availability timeline, such as an MPD, along a segment delivery path according to an embodiment. The segment delivery path may include an encoder 302, BMSC 304, Multicast Service Device Client 306 of a receiver device, and a DASH client 308 of the receiver device. The encoder 302 may encode media content into segments and deliver segments periodically to the BMSC 304. For example, segments may be periodically delivered from the encoder 302 to the BMSC 304 via the eMBMS Gateway. The BMSC 304 may receive the segments and broadcast the segments over a bearer (e.g., via OTA broadcast). The receiver device may receive the segments via a modem and Multicast Service Device Client 306 may receive the segments via the modem and process the segments (e.g., decode the segments, apply FEC, etc.) to make the segments available to a DASH client 308 of the receiver device. The DASH client 308 may provide the segments to applications (e.g., a media player) or codecs of the receiver device to enable output of the media content by the receiver device.

In addition to generating segments, the encoder 302 may generate an MPD 310. The encoder generated MPD 310 may list the segments generated and/or to be generated by the encoder 302, the segment lengths (e.g., size), and the availability time of the segments. In an embodiment, the availability times in the encoder generated MPD 310 may correspond to the output times of the encoder 302 generated segments. The encoder 302 may provide the generated MPD 310 to the BMSC 304. In an embodiment, the BMSC 304 may receive the generated MPD 310 and adjust the segment availability timeline to account for any OTA delivery delay (e.g., network jitter) to generate an MPD 312. The BMSC 304 may send the MPD 312 to the receiver device. The MPD 312 may list the segment availability times corresponding to the OTA availability times of the segments. In an embodiment, the receiver device may receive the MPD 312, and the Multicast Service Device Client 306 of the receiver device may adjust the availability times per an FDT timestamp to generate a modified MPD 314 listing the actual estimated availability time for the segments at the receiver device. The Multicast Service Device Client 306 may provide the modified MPD 314 to the DASH client 308, and the DASH client may use the segment availability times in the MPD to request segments from the local HTTP server of the receiver device using the receiver device clock. In another embodiment, the Multicast Service Device Client 306 of the receiver device adjust the availability times in the MPD 312 per the FDT timestamp and communicate the adjustments to the availability times to the DASH client 308 separate from any MPD sent to the DASH client 308.

FIG. 3B illustrates the delivery adjustments that may be made to a segment availability timeline, such as an MPD, along a segment delivery path according to another embodiment. The delivery adjustments illustrated in FIG. 3B are similar to those described above with respect to FIG. 3A, except that in FIG. 3B the Multicast Service Device Client 306 may not modify the MPD before sending it to the DASH client 308. In an embodiment, the receiver device may receive the MPD 312, and the Multicast Service Device Client 306 of the receiver device may provide the MPD 312 to the DASH client 308 without modifying the segment availability times. In an embodiment, the Multicast Service Device Client 306 may determine a delay adjustment that may be used to adjust the availability times per the FDT timestamp and generate a delay adjustment message 316 listing the delay adjustments. The Multicast Service Device Client 306 may provide the delay adjustment message to the DASH client 308. In an embodiment, the DASH client 308 may use the delay adjustment indications in delay adjustment message 316 to modify the segment availability times in the MPD 312 to generate a modified MPD 314. The DASH client 308 may request segments from the local HTTP server of the receiver device using the receiver device clock. In another embodiment, the DASH client 308 may receive the delay adjustment message 316 and use the delay adjustment message 316 to modify requests for segments from the local HTTP server of the receiver device without generating the modified MPD 314.

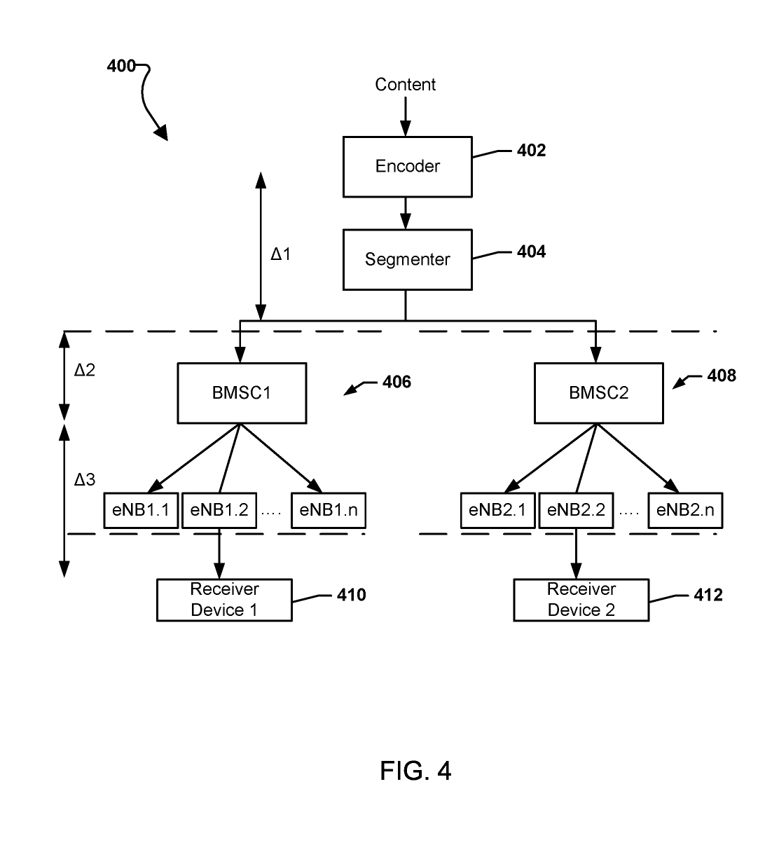

FIG. 4 illustrates the relationship between delivery path delays Δ1, Δ2, and Δ3 in different parts of a network 400 according to an embodiment. The content from the encoder 402 may pass from the encoder 402 to the segmenter 404 and be provided to two different portions of the network 406, 408 served by different BMSCs, BMSC1 and BMSC2 and their respective eNode Bs, eNB1.1, eNB1.2, eNB1.n, eNB2.1, eNB2.2, eNB2.n, etc. ENode B eNB1.2 may provide the content to receiver device 1 410 in the first portion 406, and eNode B eNB2.2 may provide the content to the receiver device 2 412 in the second portion 408. The path delay Δ1 may be the delay experienced in providing segments from the encoder to the BMSCs, BMSC1, and BMSC2. The path delay Δ2 may be the processing delay for the BMSCs, BMSC1 and BMSC2. The path delay Δ3 may be the delay experienced in providing segments from the respective BMSCs, BMSC1 or BMSC2, through their respective eNode Bs, eNB 1.1, eNB 1.2, eNB1.n, eNB2.1, eNB2.2, eNB2.n to receiver device 1 410 or receiver device 2 412, respectively. The estimated worst path delay for the network 400 may be the maximum delay along any path, e.g., (max (Δ1+Δ2+Δ3). The path delay in the first portion 406 may be different than the path delay in the second portion. Thus, the same segment of the content may be actually available at receiver device 1 410 at a different time than at receiver device 2 412 because of the different path delays Δ2 and Δ3 in the different portions 406, 408. When the path delay is less than the estimated worst case delay for the network 400, the actual availability time of segments of the content at receiver device 1 410 or receiver device 2 412 may be earlier than the availability time listed in the MPD provided to the receiver devices. The various embodiments may enable the receiver device 1 410 and/or receiver device 2 412 to account for their actual experienced path delays Δ1, Δ2, and/or Δ3, and request segments of the content when they may actually be available.

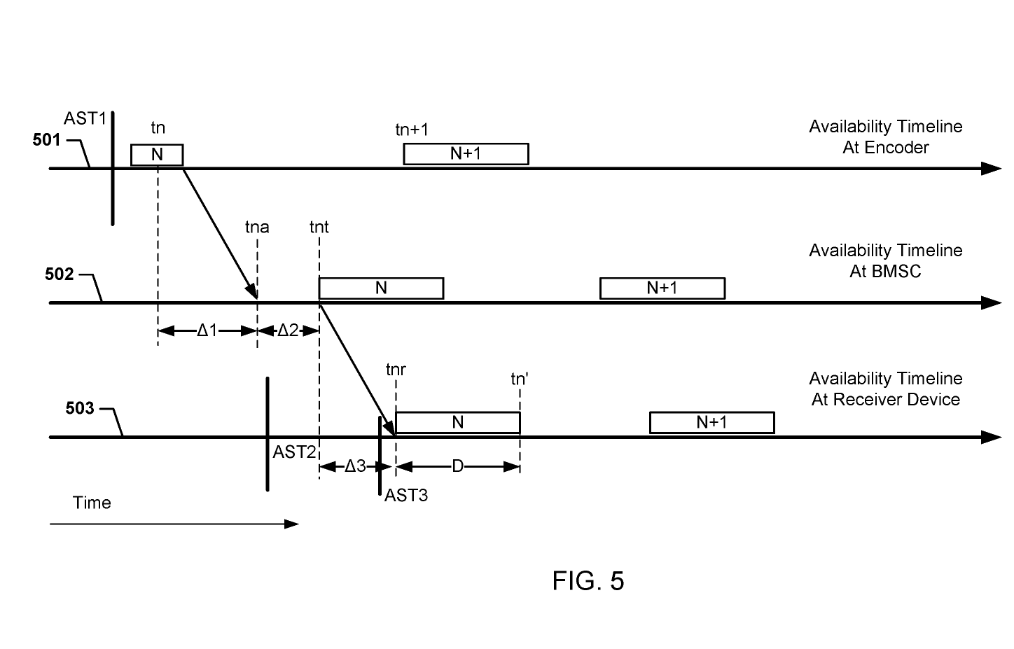

FIG. 5 illustrates availability time lines 501, 502, and 503 and their MPD availability start times AST1, AST2, and AST3 according to an embodiment. As illustrated in FIG. 5, the availability timeline 501 at the encoder may indicate an availability start time AST1 and the availability timeline 503 at the receiver device may indicate an availability start time AST2. At time tn the segment N may become available at the encoder, and at time tna the segment may arrive at the BMSC. The delay Δ1 may represent the transmission delay from the encoder to the BMSC, e.g., the difference between times tna and tn. Time tnt may be the timestamp of the transmission time of the segment N being sent to the receiver device from the BMSC. The delay Δ2 may represent the processing delay at the BMSC, e.g., the difference between times tnt and tna. Time tnr may be the timestamp of the arrival time of the segment N at the receiver device. The delay Δ3 may represent the transmission delay from the BMSC to the receiver device, e.g., the difference between times tnr and tnt. The duration D may represent the segment duration, and time tn′ may represent the segment availability time for segment N at the receiver device.

Based on the relationships of the availability times AST1 and AST2, the delays Δ1 and Δ2, the transmission timestamp tnt, and the arrival timestamp tna, the availability start time (AST2) may be determined as the availability start time AST1 plus the delay Δ1 plus the delay Δ2 plus the difference between the arrival timestamp tna and the transmission timestamp tnt plus the segment duration D (e.g., AST2=AST1+Δ1+Δ2+(tnr−tnt)+D). The receiver device may receive an MPD with the AST1 availability time, and BMSC may send the receiver device the estimates of the delays Δ1 and Δ2 and the transmission timestamp tnt. By providing the estimates of the delays Δ1 and Δ2 and the transmission timestamp tnt to the receiver device, the receiver device may be enabled to modify the availability start time AST1 in the MPD to the availability start time AST2 and generate a modified MPD to use for requesting segments when they may actually be available. Alternatively, when the MPD received by the receiver device includes an AST3 worst case delay availability time (e.g., AST3=AST1+DelayMAX), the BMSC timestamp for packet transmission may account for the same delay (e.g., tnt=transmission time+DelayMAX) timestamp.

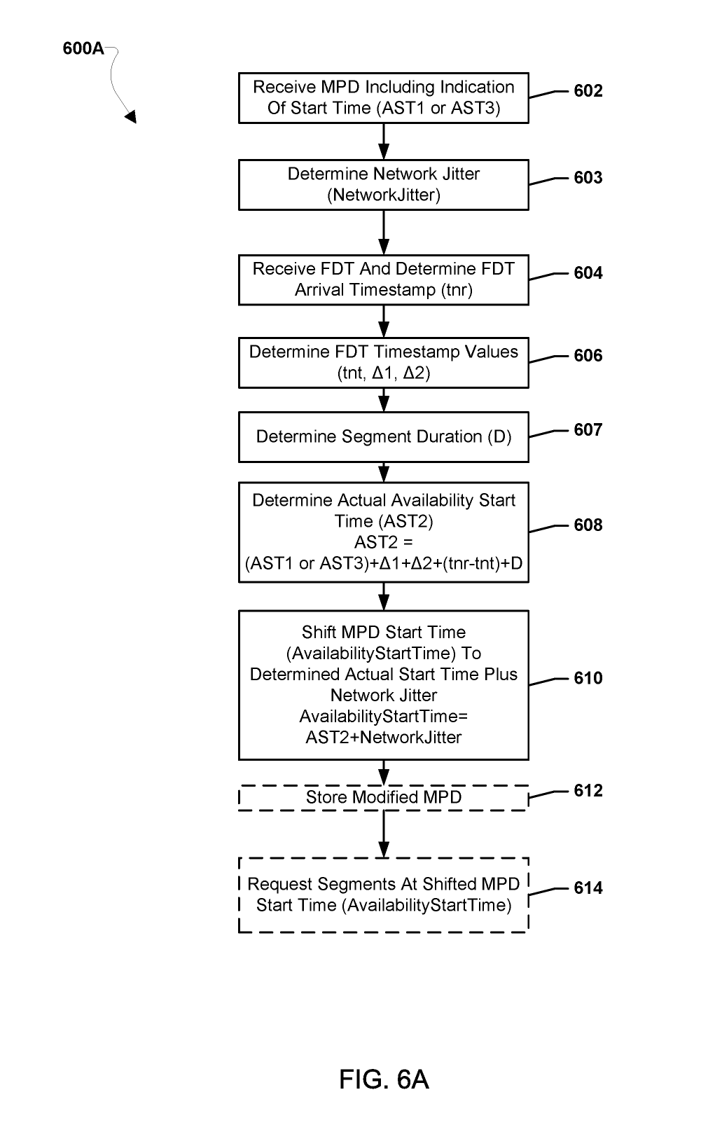

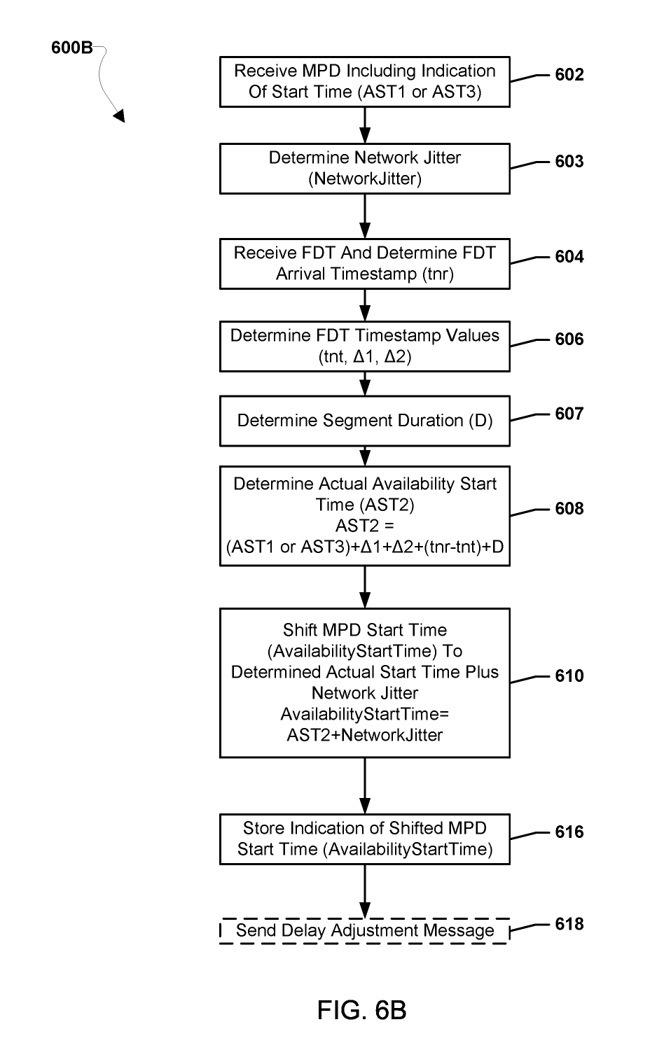

FIG. 6A is a process flow diagram illustrating an embodiment method 600A for modifying a segment availability timeline. In an embodiment, the operations of method 600A may be performed by a Multicast Service Device Client running on a processor of a receiver device, such as a smart phone. In another embodiment, the operations of method 600A may be performed by a client application, such as a DASH client, running on a processor of a receiver device. In another embodiment, the operations of method 600A may be performed by a processor of a BMSC server. In block 602 the Multicast Service Device Client, client application, or BMSC server may receive an MPD. The start time in the MPD may be the initial start time (AST1) indicated by an encoder or may be a worst case start time (AST3). In an embodiment, the device may receive the MPD via OTA transmission. In an embodiment, the MPD may be received from the network, and the headend may set the availability time of the segments in the MPD. In an embodiment, the availability time in the MPD may be set by the network and may account for the worst case end-to-end transport delay (e.g., network jitter) from the encoder generating the segments to the receiver device. In an embodiment the client application may receive the MPD via the Multicast Service Device Client.

In block 603 the Multicast Service Device Client, client application, or BMSC server may determine the network jitter. In an embodiment, the device may receive a network jitter value in a User Service Description (USD). In other embodiments, the network jitter value may be pre-provisioned and stored in a memory of the device.

In block 604 the Multicast Service Device Client, client application, or BMSC server may receive an FDT and determine the FDT arrival timestamp (tnr). In an embodiment, the FDT may include an FDT timestamp indicating one or more values, such as the FDT transmission time (tnt), the transmission delay from the encoder (Δ1), and/or the processing delay at the BMSC (Δ2). When the start time in the MPD is the initial start time (AST1), the FDT transmission time (tnt) may represent the actual time at which the FDT packet was transmitted. When the start time in the MPD is a worst case start time (AST3), the FDT transmission time (tnt) may be adjusted to account for the worst case delay (delayMAX) by adding the worst case delay (delayMAX) to the actual time at which the FDT packet was transmitted to generate a shifted transmission time (tnt=tnt+delayMAX). In an embodiment, the values may be indicated separately in the FDT timestamp, such as distinct values for tnt, Δ1, and Δ2. In another embodiment, the values may be indicated as a single value, such as the sum of Δ1+Δ2−tnt.

In block 606 the Multicast Service Device Client, client application, or BMSC server may determine the FDT timestamp values (tnt, Δ1, and Δ2). For example, the Multicast Service Device Client, client application, or BMSC server may parse the header of the FDT packet (e.g., parse the ALC header elements, ALC header extensions, FDT header extensions, etc.) to determine the FDT timestamp indicated in the FDT packet header. In block 607 the Multicast Service Device Client, client application, or BMSC server may determine the segment duration (D) of the segment associated with the FDT. The segment duration (D) may be indicated in the received MPD, in the FDT, or in another data source available to the Multicast Service Device Client, client application, or BMSC server.

In block 608 the Multicast Service Device Client, client application, or BMSC server determine the actual availability start time (AST2) as the start time from the received MPD (e.g., initial availability start time (AST1) or worst case start time (AST3)) plus the transmission delay from the encoder (Δ1) plus the processing delay at the BMSC (Δ2) plus the FDT arrival time (tnr) minus the FDT transmission time (tnt) plus the segment duration (D) (e.g., AST2=(AST1 or AST3)+Δ1+Δ2+(tnr−tnt)+D).

In block 610 the Multicast Service Device Client, client application, or BMSC server may shift the MPD start time (AvailabilityStartTime) to the determined actual start time (AST2) plus the network jitter (NetworkJitter). In this manner, the MPD may be shifted to reflect the actual time that segments may be available and account for the path delay actually experienced by the receiver device. In optional block 612 the Multicast Service Device Client, client application, or BMSC server may store the modified MPD in a memory available to the Multicast Service Device Client, client application, or BMSC server. In an embodiment, storing the modified MPD may include storing the modified MPD at a memory location associated with a URL at which some or all MPDs are stored on the receiver device or BMSC server. In another embodiment, the client application may not specifically store the modified MPD in a separate memory location. Rather, in optional block 614 the client application may merely use the modified MPD to request segments at a shifted availability time. In a further embodiment, the operations of method 600A may be repeated on a per representation basis to enable the availability times in different representations to be shifted independently.

FIG. 6B illustrates an embodiment method 600B for generating a delay adjustment message. Embodiment method 600B is similar to method 600A described above with reference to FIG. 6A, except that a delay adjustment message indicating shifts in the segment availability timeline may be generated without necessarily shifting the segment availability timeline. In an embodiment, the operations of method 600B may be performed by a Multicast Service Device Client running on a processor of a receiver device, such as a smart phone. In another embodiment, the operations of method 600B may be performed by a client application, such as a DASH client, running on a processor of a receiver device. In another embodiment, the operations of method 600B may be performed by a processor of a BMSC server.

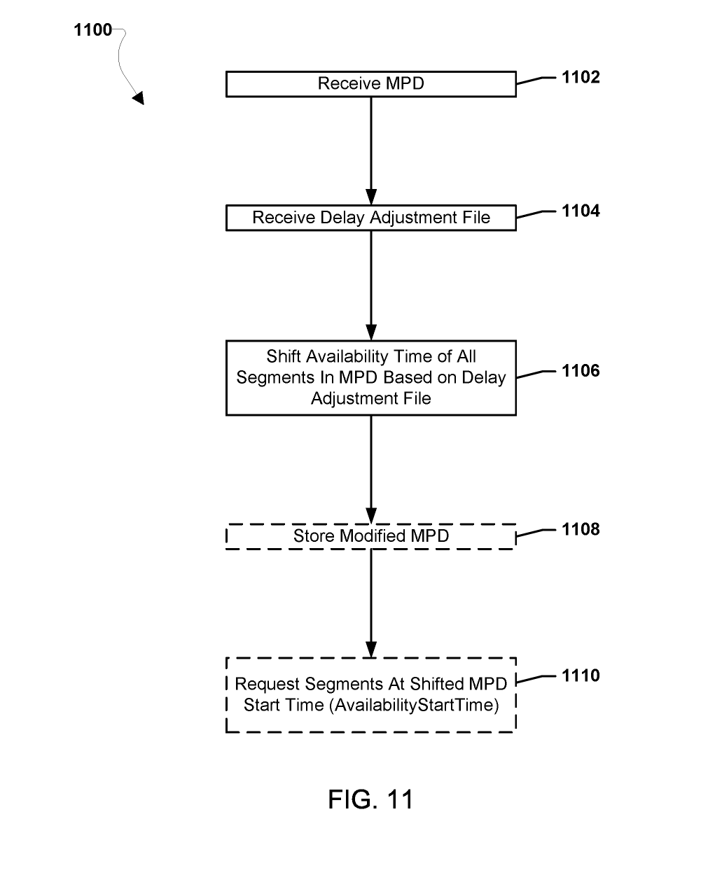

In blocks 602, 603, 604, 606, 607, 608, and 610 the Multicast Service Device Client, client application, or BMSC server may perform operations of like numbered blocks of method 600A described above with reference to FIG. 6A to determine the shifted MPD start time (AvailabilityStartTime). In block 616 the Multicast Service Device Client, client application, or BMSC server may store an indication of the shifted MPD start time (AvailabilityStartTime) in a delay adjustment message. In an embodiment, a delay adjustment message may be a data file that a client application may use to determine delay adjustments that, to account for delays in segment availability at the device, and may be used to shift the availability time of one or more segments. In an embodiment, a delay adjustment message may be stored at a memory location associated with a URL at which some or all delay adjustment messages are stored on the device. In block 618 the Multicast Service Device Client, client application, or BMSC server may send the delay adjustment message to the client application for the client application's use in shifting the availability time of one or more segments, for instance, as discussed below with reference to block 1106 of FIG. 11. In another embodiment, the delay adjustment message may not be sent, but rather accessed at or requested from its stored memory location as needed by the client application.

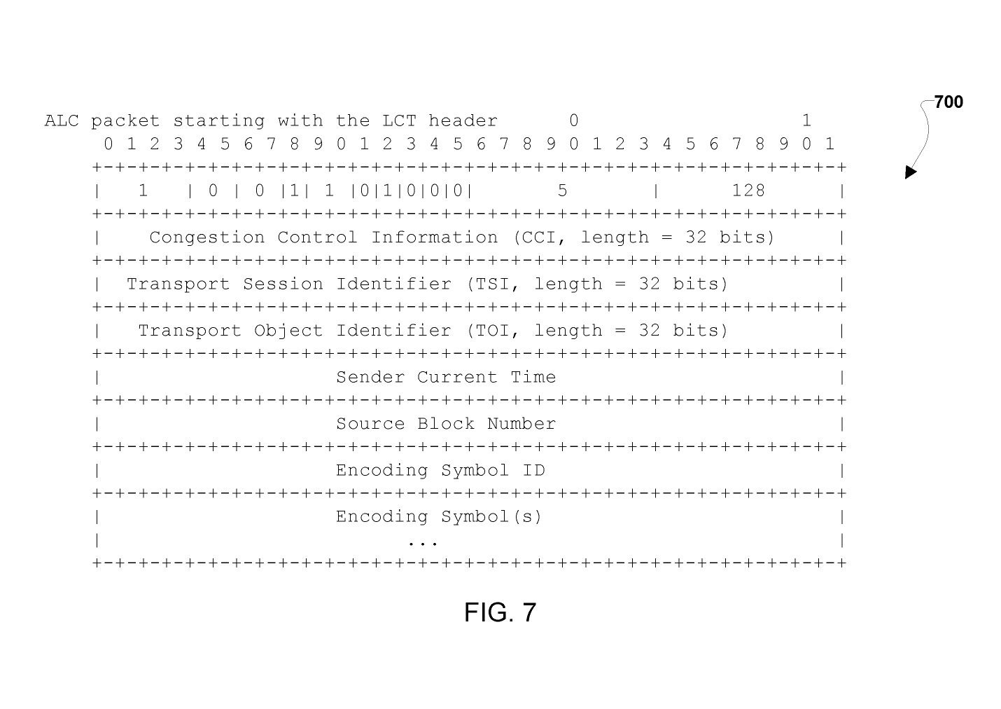

FIG. 7 is data structure diagram of an ALC packet 700 according to an embodiment. In an embodiment, the FDT timestamp may be indicated in standard ALC packet header fields, such as the sender current time (SCT) field. In other embodiments, the ALC extension headers may be used to indicate the FDT timestamp values. In an embodiment, the values may be indicated separately in the FDT timestamp, such as distinct values for tnt, Δ1, and Δ2 indicated in three separate 32 bit fields in an ALC extension header. In another embodiment, the values may be indicated as a single value, such as the sum of Δ1+Δ2−tnt indicated in a single 32 bit field in an ALC extension header.

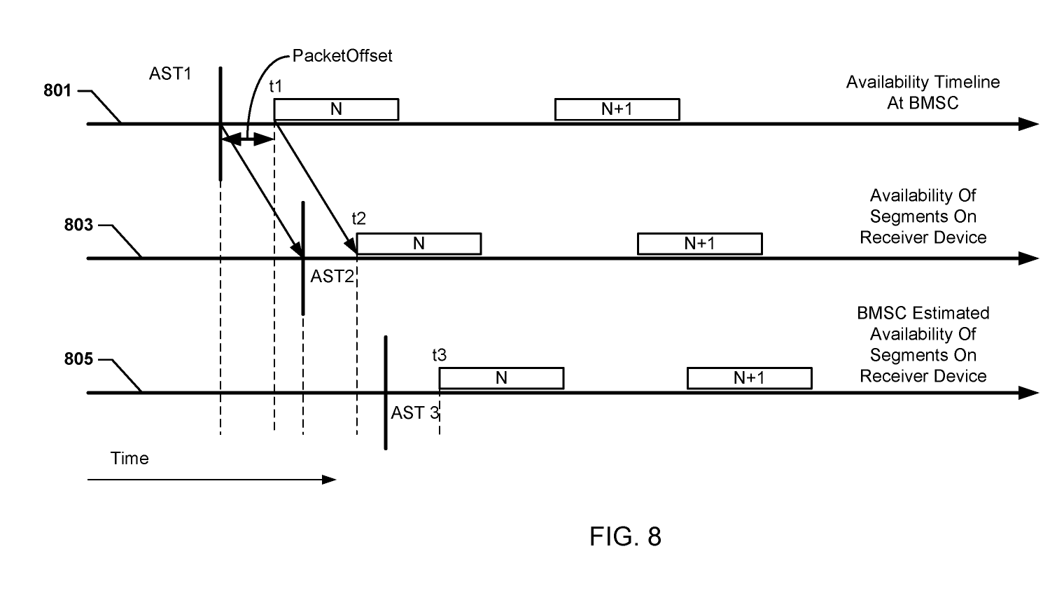

FIG. 8 illustrates MPDs 801, 803, and 805 and their availability start times AST1, AST2, and AST3, transmission times (t1, t2, and t3), arrival times, and offset times (PacketOffset) according to an embodiment. As illustrated in FIG. 8, the availability time line in the MPD 801 received at the BMSC may indicate an availability start time AST1 and a first segment N may be transmitted from the BMSC to the receiver device at time t1. The BMSC may modify the MPD 801 based on some delay to indicate an availability start time AST3 for the first segment N in the MPD 803 provided to the receiver device. However, because the path delay may be less than the estimated delay the segment N may arrive at an actual time t2, which may be less than the time t3 that the segment N would have arrived assuming the delay used by the BMSC. Thus, the segment N may be available before the time indicated in the MPD 803 and the receiver device may experience an unnecessary delay should the receiver device wait to request the segment N until the time listed in the MPD 803. To account for the actual path delay, the receiver device may generate a modified MPD 805 with the availability start time (AST2) shifted to reflect the actual time the segment N may be available. The offset time (PacketOffset) may correspond to the time between the transmission t1 and the availability time AST1, the availability start time (AST2) may be determined as the arrival time t2 minus the offset time (PacketOffset) (e.g., AST2=t2−PacketOffset). By providing the offset time (PacketOffset) to the receiver device, the receiver device may be enabled to determine the actual availability start time AST2 irrespective of the start time AST3 in the MPD 803 and generate a modified MPD 805 to reflect the actual availability start time AST2.

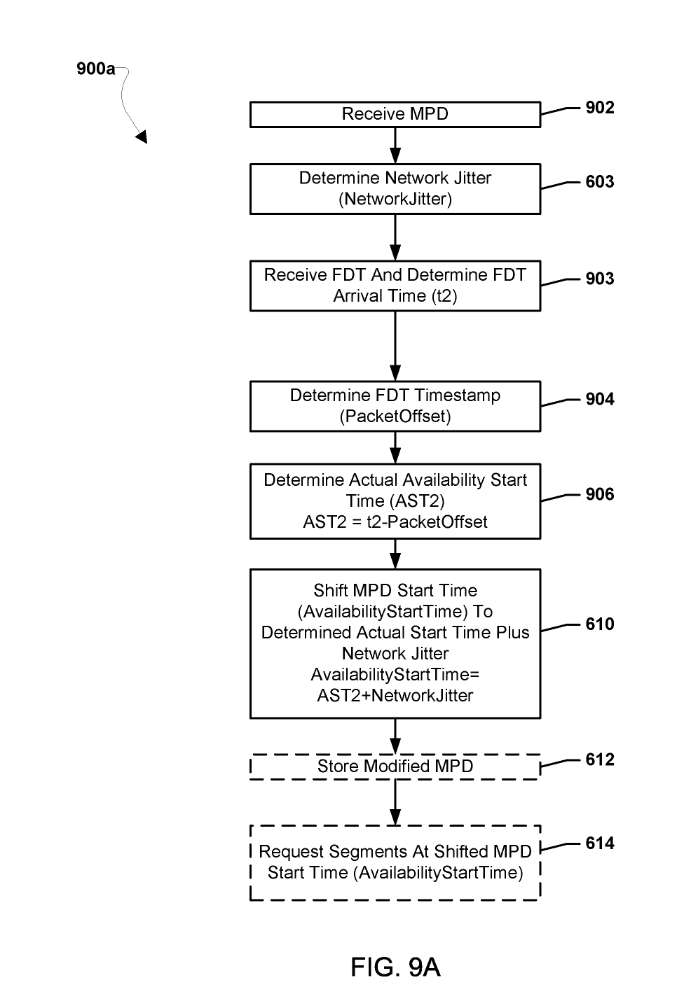

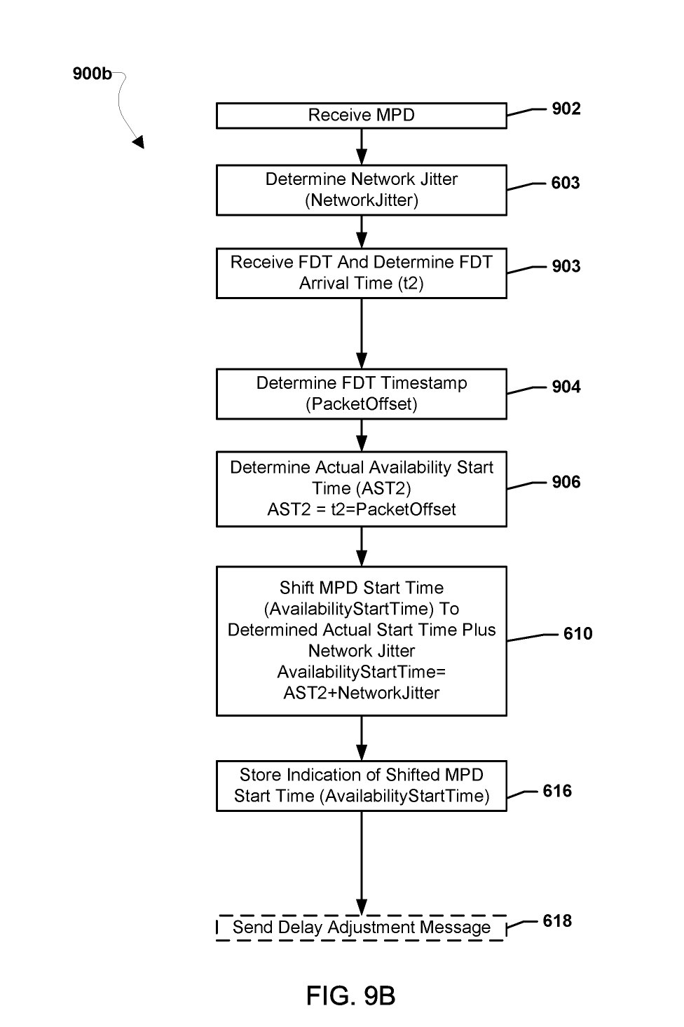

FIG. 9A is a process flow diagram illustrating an embodiment method 900a for modifying a segment availability timeline. In an embodiment, the operations of method 900a may be performed by a Multicast Service Device Client running on a processor of a receiver device, such as a smart phone. In another embodiment, the operations of method 900a may be performed by a client application, such as a DASH client, running on a processor of a receiver device. In another embodiment, the operations of method 900a may be performed by a processor of a BMSC server. In block 902 the Multicast Service Device Client, client application, or BMSC server may receive an MPD. The start time in the MPD may be any start time, such as a worst case start time or other start time. In an embodiment, the device may receive the MPD via OTA transmission. In an embodiment, the MPD may be received from the network, and the headend may set the availability time of the segments in the MPD. In an embodiment the client application may receive the MPD via the Multicast Service Device Client.

As discussed above, in block 603 the Multicast Service Device Client, client application, or BMSC server may determine the network jitter. In block 903 the Multicast Service Device Client, client application, or BMSC server may receive the FDT and determine the FDT arrival time (t2). In an embodiment, the FDT may include an FDT timestamp indicating offset time (PacketOffset) between the transmission of the FDT packet and the availability time in the MPD at the sending device. In block 904 the Multicast Service Device Client, client application, or BMSC server may determine the FDT timestamp (PacketOffset). For example, the Multicast Service Device Client, client application, or BMSC server may parse the header of the FDT packet (e.g., parse the ALC header elements, ALC header extensions, FDT header extensions, etc.) to determine the FDT timestamp indicated in the FDT packet header. In block 906 the Multicast Service Device Client, client application, or BMSC server determine the actual availability start time (AST2) as the FDT arrival time (t2) minus the FDT timestamp (PacketOffset) (e.g., AST2=t2−PacketOffset). As discussed above with reference to FIG. 6A, in blocks 610, 612, and 614 the Multicast Service Device Client, client application, or BMSC server may shift the MPD, store the modified MPD, and request segments according to the shifted MPD.

FIG. 9B illustrates an embodiment method 900b for generating a delay adjustment message. Embodiment method 900b is similar to method 900a described above with reference to FIG. 9A, except that a delay adjustment message indicating shifts in the segment availability timeline may be generated without necessarily shifting the segment availability timeline. In an embodiment, the operations of method 900b may be performed by a Multicast Service Device Client running on a processor of a receiver device, such as a smart phone. In another embodiment, the operations of method 900b may be performed by a client application, such as a DASH client, running on a processor of a receiver device. In another embodiment, the operations of method 900b may be performed by a processor of a BMSC server. In blocks 902, 603, 903, 904, 906, and 610 the Multicast Service Device Client, client application, or BMSC server may perform operations of like numbered blocks of method 900a described above with reference to FIG. 9a to determine the shifted MPD start time (AvailabilityStartTime). As discussed above with reference to FIG. 6B, in blocks 616 and 618 the Multicast Service Device Client, client application, or BMSC server may store the indication of the shifted M PD start time and send a delay message.

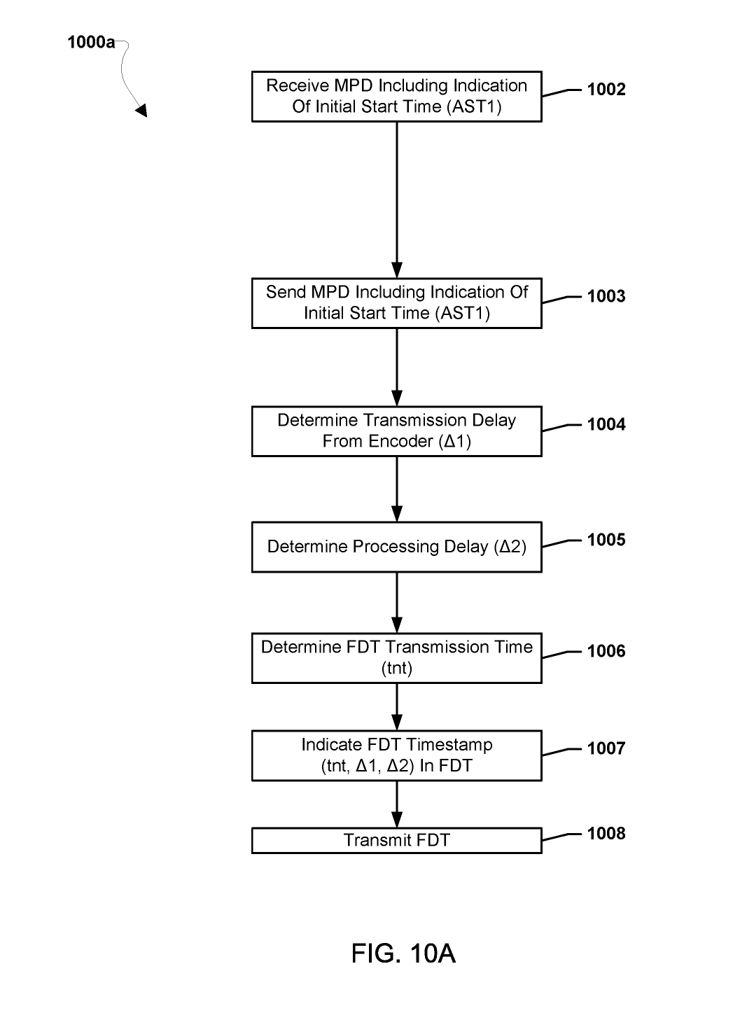

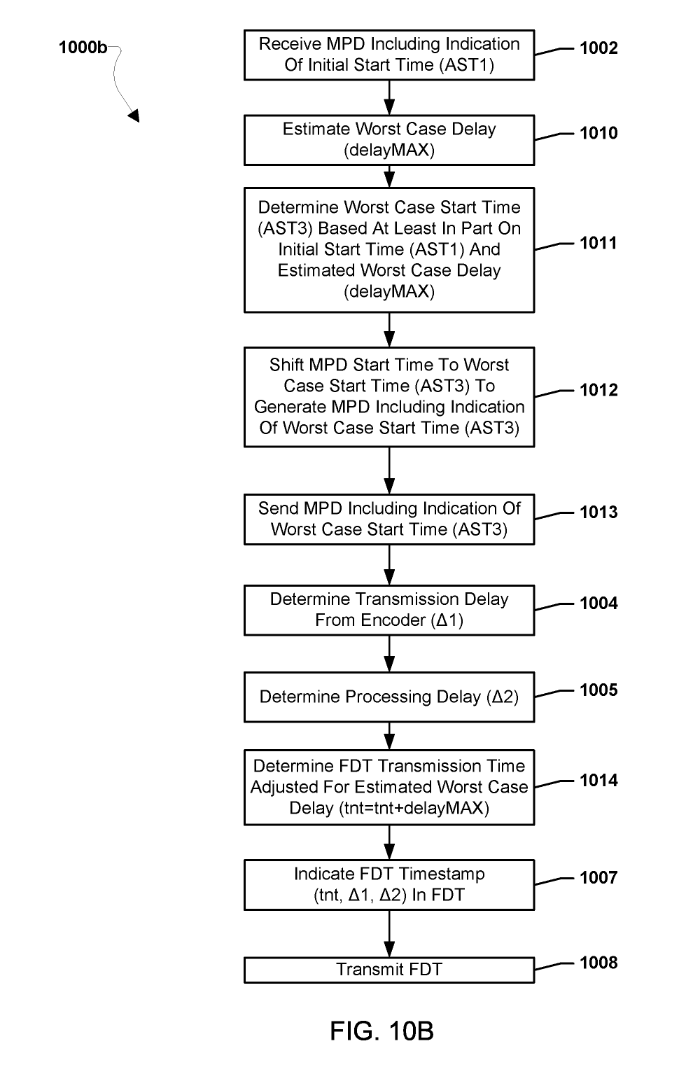

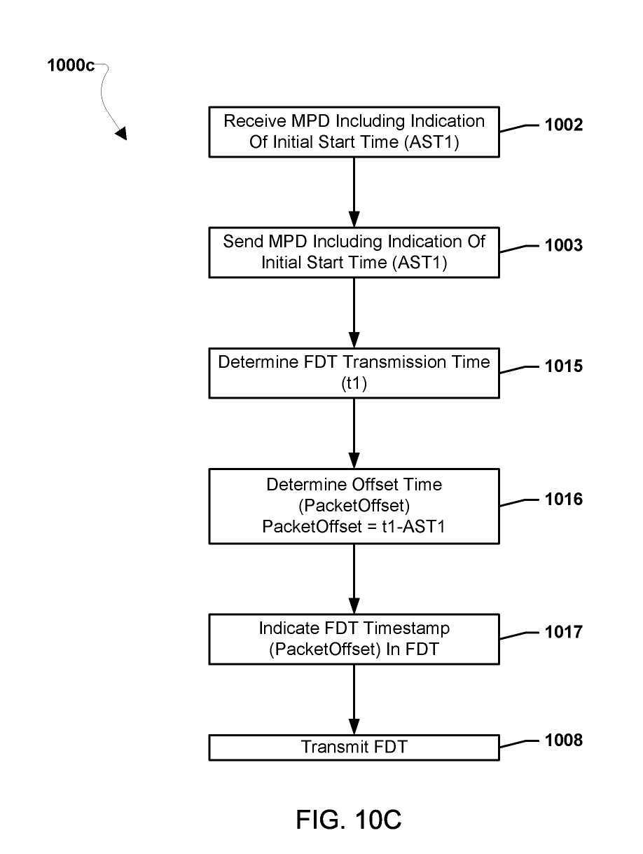

FIG. 10A is a process flow diagram illustrating an embodiment method 1000a for indicating a FDT timestamp in an FDT. In an embodiment, the operations of method 1000a may be performed by a processor of a BMSC server. In block 1002 the BMSC server may receive an MPD including an indication of an initial start time (AST1). In block 1003, the BMSC server may send the MPD including the indication of the initial start time (AST1) to the receiver device.

In block 1004, the BMSC server may determine a transmission delay from the encoder to the BMSC server (Δ1). The BMSC server may estimate the transmission delay by comparing timestamps in the packets received from the encoder to the actual time the packets were received. Alternatively, the transmission delay (Δ1) may be a pre-provisioned value stored in a memory available to the BMSC server. In block 1005, the BMSC server may determine a processing delay (Δ2) in preparing the packets for transmission. The processing delay (Δ2) may be a pre-provisioned value stored in a memory available to the BMSC server.

In block 1006, the BMSC server may determine the FDT transmission time (tnt), and in block 1007, the BMSC server may indicate the FDT timestamp (tnt, Δ1, Δ2) in the FDT. For example, the FDT timestamp may be indicated in the ALC elements of the FDT or an ALC or FDT header extension. In an embodiment, the values may be indicated separately in the FDT timestamp, such as distinct values for tnt, Δ1, and Δ2. In another embodiment, the values may be indicated as a single value, such as the sum of Δ1+Δ2−tnt. In block 1008 the BMSC server may transmit the FDT at the FDT transmission time.

FIG. 10B is a process flow diagram illustrating an embodiment method 1000b for indicating a FDT timestamp in an FDT. Embodiment method 1000b is similar to the method 1000a described above with reference to FIG. 10A, except that the worst case delay (delayMAX) may be used to shift the MPD availability start times and the FDT transmission time. In block 1002, the BMSC server may receive an MPD including an indication of an initial start time (AST1).

In block 1010, the BMSC server may estimate a worst case delay (delayMAX) for sending segments to a receiver device. In block 1011, the BMSC server may determine the worst case start time (AST3) based at least in part on the initial start time (AST1) and estimated worst case delay (delayMAX). For example, the AST3 may be determined as AST1 plus the worst case delay (delayMAX) (e.g., AST3=AST1+delayMAX).

In block 1012, the BMSC server may shift the MPD start time to the worst case start time (AST3) to generate an MPD including an indication of the worst cast start time (AST3). In block 1013, the BMSC server may send the MPD including the indication of the worst case start time (AST3) to the receiver device.

As discussed above, the BMSC server may determine the transmission delay (Δ1) and processing delay (Δ2) in blocks 1004 and 1005. In block 1014, the BMSC server may determine the FDT transmission time adjusted for the estimated worst case delay (delayMAX) (e.g., tnt=tnt+delayMAX). In this manner, the FDT timestamp sent from the BMSC server may include a transmission time (tnt) that accounts for the worst case delay used to generate the MPD with the worst case start time (AST3). As discussed above, the BMSC server may indicate the FDT timestamp (tnt, Δ1, Δ2) in the FDT in block 1007, and the BMSC server may transmit the FDT at the FDT transmission time in block 1008.

FIG. 10C is a process flow diagram illustrating an embodiment method 1000c for indicating a FDT timestamp in an FDT. Embodiment method 1000c is similar to the method 1000a described above with reference to FIG. 10A, except that the offset time (PacketOffset) may be used as the FDT timestamp rather than the transmission time plus the worst case delay.

In blocks 1002 and 1003, the BMSC server may perform operations of like numbered blocks of the method 1000a described above with reference to FIG. 10A to receive and send the MPD. In block 1015, the BMSC server may determine the FDT transmission time (t1). In block 1016, the BMSC server may determine the offset time (PacketOffset) between the transmission time (t1) and the initial start time (AST1), for example by subtracting AST1 from t1. In block 1017, the BMSC server may indicate the FDT timestamp (PacketOffset) in the FDT. For example, the FDT timestamp may be indicated in the ALC elements of the FDT or an ALC or FDT header extension. As discussed above, in block 1008, the BMSC server may transmit the FDT at the FDT transmission time (t1).

FIG. 11 illustrates an embodiment method for adjusting availability times based indications in a delay adjustment message. In an embodiment, the operations of method 1100 may be performed by a client application, such as a DASH client, running on a processor of a receiver device, such as a smart phone. In block 1102 the client application may receive an MPD. In an embodiment, the client application may receive an MPD via an HTTP server on the receiver device via a Multicast Service Device Client. In block 1104 the client application may receive a delay adjustment message. In an embodiment, the client application may receive and a delay adjustment message via an HTTP server on the receiver device via a Multicast Service Device Client. In block 1106 the client application may shift the availability time of some or all segments in the MPD based on the delay adjustment message. In an embodiment, shifting the availability time based on the delay adjustment message may include using an indication of the shifted MPD availability start time (AvailabilityStartTime) and/or other value to adjust the time at which each segment will be available on the receiver device. In an embodiment, shifting the availability time may include modifying the MPD itself to generate a modified MPD. In another embodiment, shifting the availability time may involve changing an indication of when a segment will be available on the receiver device without modifying the MPD itself. In an embodiment in which the MPD is modified, in optional block 1108 the client application may store the modified MPD in a memory available to the client application. In block 1110 the client application may request segments at the shifted MPD start time (AvailabilityStartTime).

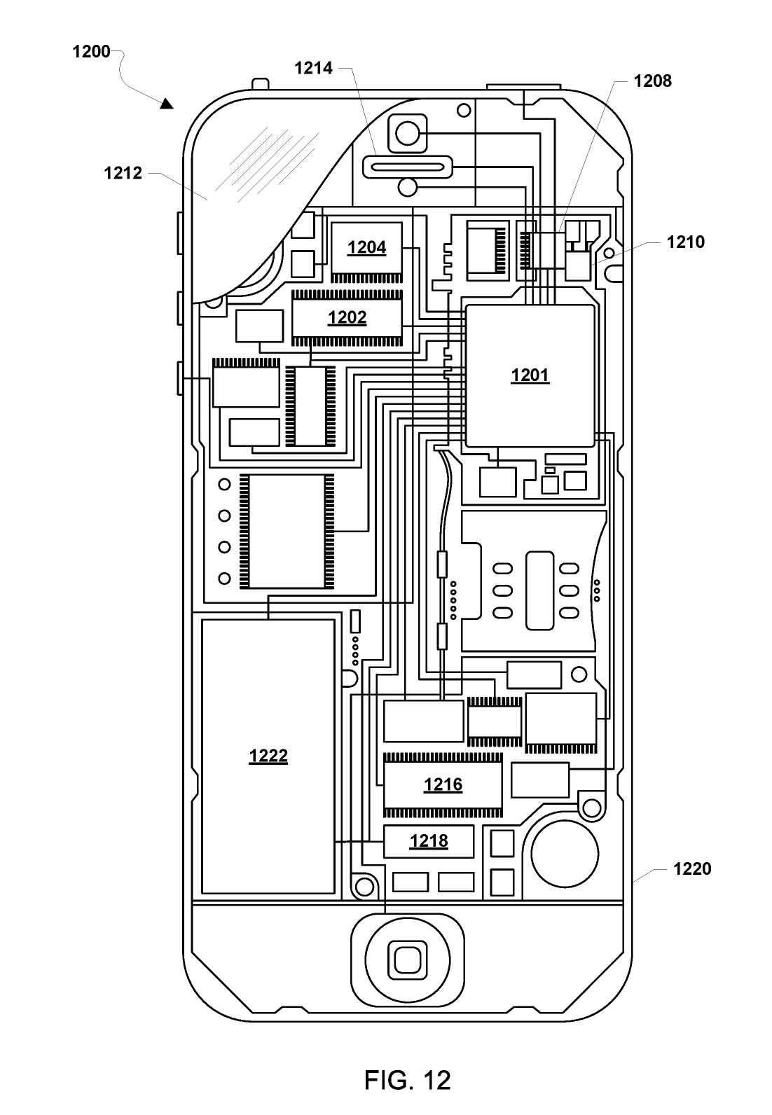

The various embodiments (including, but not limited to, embodiments discussed above with reference to FIGS. 3A, 3B, 4, 5, 6A, 6B, 7, 8, 9A, 9B, and 11) may be implemented in any of a variety of mobile devices (i.e., receiver devices), an example of which is illustrated in FIG. 12. For example, the mobile computing device 1200 may include a processor 1201 coupled to a touch screen controller 1204 and an internal memory 1202. The processor 1201 may be one or more multicore integrated circuits (ICs) designated for general or specific processing tasks. The internal memory 1202 may be volatile or non-volatile memory, and may also be secure and/or encrypted memory, or unsecure and/or unencrypted memory, or any combination thereof. The touch screen controller 1204 and the processor 1201 may also be coupled to a touch screen panel 1212, such as a resistive-sensing touch screen, capacitive-sensing touch screen, infrared sensing touch screen, etc. The mobile computing device 1200 may have one or more radio signal transceivers 1208 (e.g., Peanut®, Bluetooth®, Zigbee®, Wi-Fi, RF, cellular, etc.) and antennae 1210, for sending and receiving, coupled to each other and/or to the processor 1201. The transceivers 1208 and antennae 1210 may be used with the above-mentioned circuitry to implement the various wireless transmission protocol stacks and interfaces. The mobile computing device 1200 may include a cellular network wireless modem chip 1216 that enables communication via a cellular network and is coupled to the processor. The mobile computing device 1200 may include a peripheral device connection interface 1218 coupled to the processor 1201. The peripheral device connection interface 1218 may be singularly configured to accept one type of connection, or multiply configured to accept various types of physical and communication connections, common or proprietary, such as USB, FireWire, Thunderbolt, or PCIe. The peripheral device connection interface 1218 may also be coupled to a similarly configured peripheral device connection port (not shown). The mobile computing device 1200 may also include speakers 1214 for providing audio outputs. The mobile computing device 1200 may also include a housing 1220, constructed of a plastic, metal, or a combination of materials, for containing all or some of the components discussed herein. The mobile computing device 1200 may include a power source 1222 coupled to the processor 1201, such as a disposable or rechargeable battery. The rechargeable battery may also be coupled to the peripheral device connection port to receive a charging current from a source external to the mobile computing device 1200.

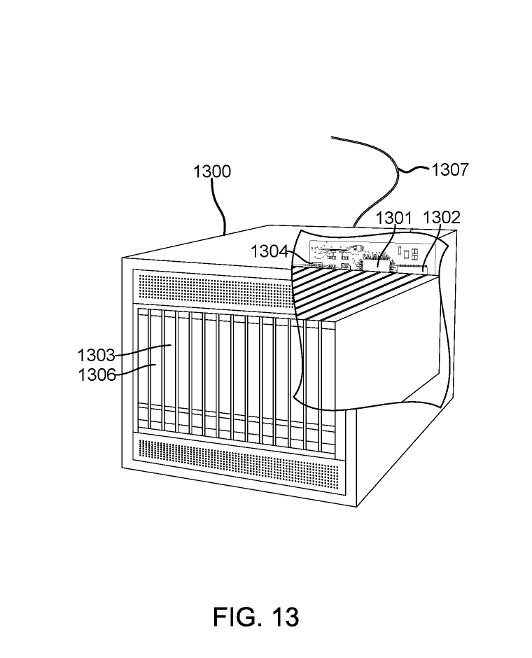

The various embodiments (including, but not limited to, embodiments discussed above with reference to FIGS. 3A, 3B, 4, 5, 6A, 6B, 7, 8, 9A, 9B, 10A, 10B, and 11) may also be implemented on any of a variety of commercially available server devices, such as the server 1300 illustrated in FIG. 13. Such a server 1300 typically includes a processor 1301 coupled to volatile memory 1302 and a large capacity nonvolatile memory, such as a disk drive 1304. The server 1300 may also include a floppy disc drive, compact disc (CD) or DVD disc drive 1306 coupled to the processor 1301. The server 1300 may also include one or more network transceivers 1303, such as a network access port, coupled to the processor 1301 for establishing network interface connections with a communication network 1307, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

The processors 1201 and 1301 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 1201 and 1301. The processors 1201 and 1301 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1201 and 1301 including internal memory or removable memory plugged into the device and memory within the processors 1201 and 1301 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or computer-executable instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for modifying a segment availability timeline, comprising:
receiving a segment availability timeline at a device;
receiving a File Delivery Table (FDT) packet at the device, the FDT packet including a FDT timestamp;
determining an FDT arrival time at the device;
determining an actual availability start time at the device based at least in part on the FDT arrival time and the FDT timestamp; and
shifting a start time of the segment availability timeline based at least in part on the determined actual availability start time.

2. The method of claim 1, wherein:
the start time of the segment availability timeline when received at the device is a start time based at least in part on an estimated worst case delay;
the FDT timestamp is a transmission time of the FDT packet plus the estimated worst case delay; and
determining an actual availability start time at the device based at least in part on the FDT arrival time and the FDT timestamp comprises determining an actual availability start time as the start time based at least in part on the estimated worst case delay plus the FDT timestamp.

3. The method of claim 1, wherein:
the FDT timestamp is an offset time determined by a device sending the FDT packet; and
determining an actual availability start time at the device based at least in part on the FDT arrival time and the FDT timestamp comprises determining an actual availability start time as the FDT arrival time minus the FDT timestamp.

4. The method of claim 3, wherein the offset time determined by a device sending the FDT packet is a time between an initial availability start time and a transmission time of the FDT packet by the device sending the FDT packet.

5. The method of claim 1, wherein:
the start time of the segment availability timeline when received at the device is an initial start time;
the FDT timestamp comprises a transmission time of the FDT packet, a transmission delay, and a processing delay; and
determining an actual availability start time at the device based at least in part on the FDT arrival time and the FDT timestamp comprises determining an actual availability start time as the start time based at least in part on the transmission time of the FDT packet, the transmission delay, and the processing delay.

6. The method of claim 5, further comprising determining a segment duration, wherein determining an actual availability start time as the start time based at least in part on the transmission time of the FDT packet, the transmission delay, and the processing delay comprises determining an actual availability start time as the start time based at least in part on the transmission time of the FDT packet, the transmission delay, the processing delay, and the segment duration.

7. The method of claim 6, wherein the FDT timestamp is indicated in the FDT packet.

8. The method of claim 7, wherein the FDT timestamp is indicated in a sender current time field of an ALC packet header.

9. The method of claim 5, wherein the FDT timestamp is indicated in an ALC or FDT extension header.

10. The method of claim 1, further comprising determining a network jitter estimate, wherein shifting a start time of the segment availability timeline based at least in part on the determined actual availability start time comprises shifting a start time of the segment availability timeline based at least in part on the determined actual availability start time and the determined network jitter estimate.

11. The method of claim 10, wherein shifting a start time of the segment availability timeline based at least in part on the determined actual availability start time and the determined network jitter estimate comprises adding the determined network jitter estimate to the determined actual availability start time.

12. The method of claim 1, wherein the segment availability timeline is a Dynamic Adaptive Streaming Over Hypertext Transfer Protocol (DASH) Media Presentation Description (MPD).

13. The method of claim 1, wherein the device is a receiver device or a Broadcast Multimedia Service Center (BMSC) server.

14. A method for transmitting a File Delivery Table (FDT) packet, comprising:
determining a transmission time of the FDT packet;
indicating a FDT timestamp in the FDT packet, wherein the FDT timestamp is based at least in part on the determined transmission time; and
transmitting the FDT packet at the determined transmission time.

15. The method of claim 14, further comprising estimating a worst case delay for transmission of the FDT packet, wherein the FDT timestamp is the transmission time of the FDT packet plus the estimated worst case delay.

16. The method of claim 14, wherein the FDT timestamp is an offset time.

17. The method of claim 16, wherein the offset time is a time between an initial availability start time and the transmission time of the FDT packet.

18. The method of claim 14, wherein the FDT timestamp is a transmission time of the FDT packet, a transmission delay, and a processing delay.

19. The method of claim 18, wherein the FDT timestamp is indicated in a sender current time field of an ALC packet header.

20. The method of claim 18, wherein the FDT timestamp is indicated in an ALC or FDT extension header.

21. The method of claim 14, further comprising shifting a Dynamic Adaptive Streaming Over Hypertext Transfer Protocol (DASH) Media Presentation Description (MPD) and sending the MPD.

22. A device, comprising:
a processor configured with processor-executable instructions to perform operations comprising:
receiving a segment availability timeline;
receiving a File Delivery Table (FDT) packet, the FDT packet including a FDT timestamp;
determining an FDT arrival time;
determining an actual availability start time based at least in part on the FDT arrival time and the FDT timestamp; and
shifting a start time of the segment availability timeline based at least in part on the determined actual availability start time.

23. The device of claim 22, wherein:
the start time of the segment availability timeline when received at the device is a start time based at least in part on an estimated worst case delay;
the FDT timestamp is a transmission time of the FDT packet plus the estimated worst case delay; and
the processor is configured with processor-executable instructions to perform operations such that determining an actual availability start time based at least in part on the FDT arrival time and the FDT timestamp comprises determining an actual availability start time as the start time based at least in part on the estimated worst case delay plus the FDT timestamp.

24. The device of claim 22, wherein:
the FDT timestamp is an offset time determined by a device sending the FDT packet; and
the processor is configured with processor-executable instructions to perform operations such that determining an actual availability start time based at least in part on the FDT arrival time and the FDT timestamp comprises determining an actual availability start time as the FDT arrival time minus the FDT timestamp.

25. The device of claim 22, wherein:
the start time of the segment availability timeline when received at the device is an initial start time;
the FDT timestamp comprises a transmission time of the FDT packet, a transmission delay, and a processing delay; and
the processor is configured with processor-executable instructions to perform operations such that determining an actual availability start time based at least in part on the FDT arrival time and the FDT timestamp comprises determining an actual availability start time as the start time based at least in part on the transmission time of the FDT packet, the transmission delay, and the processing delay.

26. The device of claim 22, wherein:
the processor is configured with processor-executable instructions to perform operations further comprising determining a network jitter estimate; and
the processor is configured with processor-executable instructions to perform operations such that shifting a start time of the segment availability timeline based at least in part on the determined actual availability start time comprises shifting a start time of the segment availability timeline based at least in part on the determined actual availability start time and the determined network jitter estimate.

27. The device of claim 22, wherein the segment availability timeline is a Dynamic Adaptive Streaming Over Hypertext Transfer Protocol (DASH) Media Presentation Description (MPD).

28. A device, comprising:
a processor configured with processor-executable instructions to perform operations comprising:
determining a transmission time of a File Delivery Table (FDT) packet;
indicating a FDT timestamp in the FDT packet, wherein the FDT timestamp is based at least in part on the determined transmission time; and
transmitting the FDT packet at the determined transmission time.

29. The device of claim 28, wherein:
the processor is configured with processor-executable instructions to perform operations further comprising estimating a worst case delay for transmission of the FDT packet; and
the processor is configured with processor-executable instructions to perform operations such that the FDT timestamp is the transmission time of the FDT packet plus the estimated worst case delay.

30. The device of claim 22, wherein the processor is configured with processor-executable instructions to perform operations further comprising shifting a Dynamic Adaptive Streaming Over Hypertext Transfer Protocol (DASH) Media Presentation Description (MPD) and sending the MPD.
